(19) United States
(12) Patent Application Publication
(10) Pub. No.: US 2013/0159443 A1
(43) Pub. Date: Jun. 20, 2013

(54) SYSTEM AND METHOD FOR PROVIDING CUSTOMIZABLE COMMUNICATIONS

(71) Applicant: Parlant Technology, Inc., Provo, UT (US)

(72) Inventors: Dane Drew Dellenbach, Pleasant Grove, UT (US); Bruce G. Hassler, Mapleton, UT (US); Tyson L. Holmes, American Fork, UT (US)

(73) Assignee: Parlant Technology, Inc., Provo, UT (US)

(21) Appl. No.: 13/767,722

(22) Filed: Feb. 14, 2013

Related U.S. Application Data
(63) Continuation-in-part of application No. 13/348,221, filed on Jan. 11, 2012.
Application No. 13/348,221 is a continuation-in-part of application No. 13/188,393, filed on Jul. 21, 2011.
Application No. 13/188,393 is a continuation-in-part of application No. 13/709,293, filed on Dec. 10, 2012.

(51) Int. Cl. H04L 12/58

(52) U.S. Cl. CPC H04L 12/5815
USPC 709/206

(57) ABSTRACT

The various implementations of the present invention are provided as a computer-based system configured to allow for controlling the flow of communication options in a multi-user, multi-organizational environment. The computer-based system focuses on providing significant customization of the communication flow, delivery, and relevance by focusing on intermediation and integration of multiple disparate messaging platforms that may be used by a message originator to send messages to a message originator, providing for an integrated messaging platform. Additional embodiments provide for automated or enhanced communication using variables such as place, time, message recipient affiliation, etc. to prioritize and adapt message flow for a specific person or organization. While useful for many different environments, the most preferred embodiments of the present invention are adapted for use in an educational environment.

### RELATED APPLICATION

This patent application is a continuation-in-part of U.S. patent application Ser. No. 13/348,221 which application was filed on Jan. 11, 2012, which application is now pending and which application is incorporated herein by reference. U.S. patent application Ser. No. 13/348,221 is a continuation-in-part of U.S. patent application Ser. No. 13/188,393 which application was filed on Jul. 21, 2011, which application is now pending and which application is incorporated by reference herein. This patent application is also a continuation-in-part of U.S. patent application Ser. No. 13/709,293 which application was filed on Dec. 10, 2012, which application is now pending and which application is also incorporated herein by reference.

### BACKGROUND OF THE INVENTION

1. Technical Field

The present invention relates generally to the field of interactive communication and more specifically relates to systems and methods for monitoring and controlling various aspects of communication flow for certain environments.

2. Background Art

Most schools, businesses, government agencies, and other organizations will often find it useful to communicate various messages to their constituents or potential constituents (e.g., administrators, managers, employees, workers, students, parents, teachers, etc.). Since communication in the world today encompasses much more than simple messaging tasks such as phone calls and letters, many entities are finding it increasingly difficult to maintain the desired level of communication with the desired audience. Additionally, since enhanced communication usually leads to more active involvement in the community, most organizations are constantly seeking opportunities to engage their constituencies through the increased dissemination of more relevant messages.

For example, many organizations are rapidly adapting their communication programs to include or incorporate the use of communication technologies that did not even exist 10 years ago. Social media messaging platforms such as Twitter®, Facebook®, Tumblr®, Instagram®, Google Chat®, MySpace®, Google+®, etc. are all relatively new social media messaging platforms that have seen broad acceptance for exchanging messages between users. Each of these communication messaging platforms has a unique specific interface and protocol, including an application programming interface (“API”). Many users have accounts with multiple social media messaging platforms. It may be difficult for many organizations to efficiently utilize all of them because not all people use all possible social media messaging platforms. It can be difficult to send messages to a disparate user base without preparing and formatting the message for proper delivery to a wide variety of potential message delivery applications.

Further, in many situations, certain communications should not be sent by certain message originators to certain message recipients using the relatively unmonitored and unfiltered social media messaging platforms. For example, in an educational environment, it may not be appropriate or desirable for a teacher to correspond with a student via a social messaging platform (e.g., Facebook®) because it may lead to inappropriate communications between the student and the teacher. However, since social media messaging platforms are one of the most common communication platforms used by parents as well as junior high school, high school, and college students, eliminating the use of social media messaging for communication purposes may be somewhat counterproductive. In a work environment, it may not be appropriate or desirable for a supervisor to correspond with an employee or for an employee to correspond with a co-worker regarding work matters since it may lead to inappropriate communications for which the employer may be liable.

The elimination of the natural flow of communication between message originators and message recipients via social media messaging platforms may create unwanted communication breakdown and lead to less frequent communication of important messages. This is not a desirable outcome and is, in fact, the polar opposite of what most organizations are trying to accomplish by integrating social media messaging into their communication plans. Accordingly, without improvements in the current systems, procedures, and methods for monitoring and controlling the flow of communication in certain environments, the ability to ensure that communications and messages are being delivered in the most appropriate and desirable manner will continue to be suboptimal.

### BRIEF SUMMARY OF THE INVENTION

The various implementations of the present invention are provided as a computer-based system configured to allow for controlling the flow of communication options in a multi-user, multi-organizational environment. The computer-based system focuses on providing significant customization of the communication flow, delivery, and relevance by focusing on intermediation and integration of multiple disparate messaging platforms that may be used by a message originator to send messages to a message recipient, providing for an integrated messaging platform. Additional embodiments provide for automated or enhanced communication using variables such as place, time, message recipient affiliation, etc. to prioritize and adapt message flow for a specific person or organization. While useful for many different environments, the most preferred embodiments of the present invention are adapted for use in an educational environment.

### BRIEF DESCRIPTION OF THE FIGURES

The preferred embodiments of the present invention will hereinafter be described in conjunction with the appended drawings, wherein like designations denote like elements, and:

FIG. 1 is a schematic diagram of a computer-based system for controlling and monitoring the flow of communication in accordance with a preferred exemplary embodiment of the present invention;

FIG. 2 is a block diagram of a server used for implementing a computer-based system for controlling and monitoring the flow of communication in accordance with a preferred exemplary embodiment of the present invention;

FIG. 3 is a block diagram illustrating the interaction between message originators and message recipients when using a computer-based system for controlling and monitoring the flow of communication in accordance with a preferred exemplary embodiment of the present invention;

FIG. 4 is a flow chart of a method for implementing a computer-based system for controlling and monitoring the flow of communication in accordance with a preferred exemplary embodiment of the present invention;

FIG. 5 is a block diagram of the communication flow between various entities using a computer-based system for controlling and monitoring the flow of communication in accordance with a preferred exemplary embodiment of the present invention; and

FIG. 6A, FIG. 6B, FIG. 6C, and FIG. 6D comprise a series of schematic representations of a user interface on a mobile communication device for accessing a computer-based system for controlling and monitoring the flow of communication in accordance with a preferred exemplary embodiment of the present invention.

### DETAILED DESCRIPTION OF THE INVENTION

The various implementations of the present invention are provided as a computer-based system configured to allow for controlling the flow of communication options in a multi-user, multi-organizational environment. The computer-based system focuses on providing significant customization of the communication flow, delivery, and relevance by focusing on intermediation and integration of multiple disparate social media messaging platforms that may be used by a message originator to send messages to a message recipient, providing for an integrated messaging platform. Additional embodiments provide for automated or enhanced communication using variables such as place, time, message recipient affiliation, etc. to prioritize and adapt message flow for a specific person or organization. While useful for many different environments, the most preferred embodiments of the present invention are adapted for use in an educational environment.

The various preferred embodiments of the present invention are specifically designed to provide a user-configurable platform for integration of communications or “messages” from multiple disparate sources, including schools, community groups, commercial enterprises, social media networks, municipalities, etc. Specifically, the present invention provides for flexible and customizable configuration of messages and communication streams or messages that allow for more effective and efficient communication between individuals and organizations, while isolating the message recipient's social media identity and account access from the message originator.

For purposes of this disclosure, a “message” is any type of communication or message generated by a person or entity that is meant for consumption by another person or entity. This definition includes standard media broadcast signals, RSS messages, Twitter® “tweets,” Facebook® and other social media posts, SMS text messages, pre-recorded audio and video streams, etc. In the most preferred embodiments of the present invention, at least one educational message, generated by a school or school district will be provided. The educational message may be directed towards a parent and will generally contain information about the parent's child and school. The messages described herein are most preferably streamed to a mobile phone or other portable communication device but may also be used with other computer systems such as a desktop.

These messages may include school activity information and information about the child's class or about activities for students at the same grade level as the child. For purposes of this disclosure, a “private message” refers to confidential messages that are shared with authorized individuals only. For example, a school may be authorized to send a private message about a student to the student, the student's parents or guardians, and designated administrators at the school, but not with any other individuals. It is important to comply with these restrictions because the disclosure of certain confidential or private information to unauthorized individuals may be a violation of the law (e.g., Family Educational Rights and Privacy Act or “FERPA”).

For purposes of this disclosure, a “public message” refers to messages containing non-confidential information that may be shared with any number of individuals, without regard to any privacy issues or concerns. In other preferred embodiments of the present invention, the message may be a hybrid message, containing both public information and confidential or private information that should not be shared with any other person or group. In these cases, the inclusion of private on confidential information in the hybrid message would result in the hybrid message being processed as if all of the content were private or confidential (e.g., a “private message”).

A message may be generated by an organization, a commercial business enterprise, a trade union, a fraternal organization, or a state or local governmental agency or municipality and include information of importance to their communities and constituencies. In some preferred embodiments, a message may be generated which contains information from personal messages, which is aggregated with an organization message. Additionally, other types of messages may be generated by news agencies, sports teams, entertainment venues, etc. All of these messages may be made available via various technologies, including social media messaging platforms.

Aspects of the computer-based system for providing customizable messages 100 are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Additionally, various preferred embodiments of the program product may be configured to: create and modify multiple databases; track, update and store data relative to customized communications and messages; configure and implement various search and retrieve functions for a multitude of search requests and determinations made by users for providing information; track and store information about various services and program features; update and transmit results to one or more message recipients; and provide one or more user interfaces for accomplishing all of these functions.

In this fashion, the appropriate entities (i.e., business owners, managers, administrators, teachers, parents, students, etc.) can utilize the program product to initiate and complete a wide variety of database-related applications for the provision of enhanced communication flow. Similarly, a program product in accordance with one or more preferred embodiments of the present invention can also be configured to perform substantially all of the steps depicted and described in conjunction with the figures below for implementing a communication and messaging system as described herein.

While the present invention will be described in detail by using various examples of a typical educational environment, those skilled in the art will recognize that the equipment, processes, methods and techniques described herein have broad applicability to other environments and applications where quick and efficient access to customizable communication services is desirable.

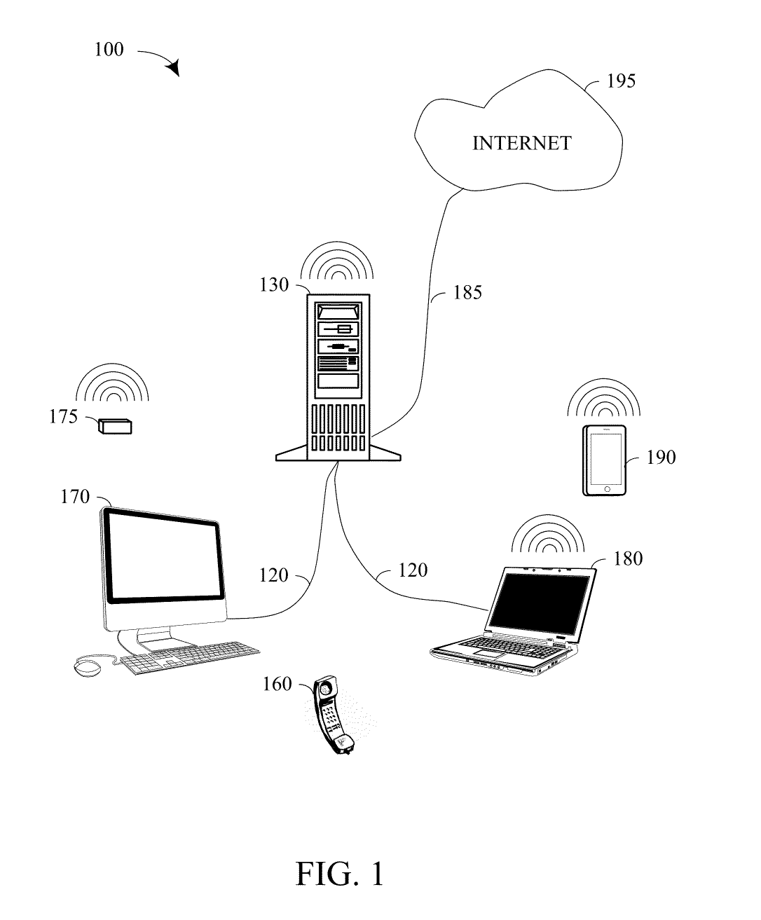

Referring now to FIG. 1, a computer-based system 100 for controlling and monitoring the flow of communication in accordance with a preferred exemplary embodiment of the present invention comprises: a data server 130; at least one of a desktop computer 170 or a laptop computer 180; a telephone 160; a wireless communication device 175; and an optional mobile communication device 190 (e.g., smartphone or personal digital assistant “PDA”) all connected or coupled via a local area network 120 to the Internet 195 via an Internet connection 185.

Taken together, the components of computer-based system 100 provide a platform for creating messages as well as providing a facility for monitoring and controlling the flow of messages from one or more message originators to one or more message recipients, using a plurality of social media messaging platforms as an intermediary to deliver the messages. Computer-based system 100 provides a mechanism for a group of information providers and information consumers to efficiently and effectively create, send, and receive messages using various social media messaging platforms, without having any user identity information (e.g., “handle”) about the social media accounts of the other participants in the messaging process.

In the most preferred embodiments of the present invention, computer-based system 100 is configured as a system that will be used to create and send relevant messages for an educational community in a typical school environment. In this preferred embodiment, the group of users of computer-based system 100 will typically include administrators for individual schools as well as school board and school district officials, teachers, staff, community members, parents, and students.

Network 120 represents any suitable computer communication link or similar communication mechanism, including some combination of a hardwired connection, an internal or external bus, a connection for telephone access via a modem, standard co-axial cable lines, high-speed T1 line, radio, infrared or other wireless communication methodologies (e.g., “Bluetooth,” infrared (IR), etc.), private or proprietary local area networks (LANs) and wide area networks (WANs), as well as standard computer network communications over Internet 195 or an internal network (e.g. “intranet”) via a wired or wireless connection, or any other suitable connection between computers and computer components known to those skilled in the art, whether currently known or developed in the future. It should be noted that portions of network 120 might suitably include a dial-up phone connection, a broadcast cable transmission line, a Digital Subscriber Line (DSL), an ISDN line, or similar public utility-like access link.

In the most preferred embodiments of the present invention, at least a portion of network 120 comprises a standard Internet connection 185 between at least some of the components of computer-based system 100 for providing access to additional network resources and other remote locations. Network 120 provides for communication between the various components of computer-based system 100 and allows for relevant information to be transmitted from device to device. In this fashion, a user of computer-based system 100 can quickly and easily gain access to the relevant data and information utilized to search, retrieve, and display information from one or more databases as described in conjunction with the preferred embodiments of the present invention.

In the most preferred embodiments of the present invention, network 120 is configured to provide relatively high-speed transmission of textual information, audio and video data and signals, and also comprises at least an Internet connection 185 for transmission of data captured by one or more computers 170 or 180 and a phone 160 for transmission of an audio signal to and from a standard phone connection. The phone connection may be interfaced to a standard phone system typically found in most homes and commercial facilities, including for example, the existing “land line” phone system infrastructure and/or digital cellular phone communication systems.

In addition to the other components shown in FIG. 1, a wireless communication access device 175 may be communicatively coupled to network 120 and may be any type of wireless communication mechanism that is known to those skilled in the art to provide for wireless communication between network 120 and the various devices associated with network 120, including desktop computer 170, laptop computer 180 and phone 160 as well as mobile communication device 190. The most preferred embodiments of an acceptable wireless communication access device may comprise any type of wireless bridge, wireless router, or wi-fi “hotspot.”

Regardless of the specific components, physical nature, and topology, network 120 serves to logically and communicatively link the physical components of computer-based system 100, thereby enabling stable and consistent communication between the components. This is especially important because in many preferred embodiments of the present invention, data server 130, desktop computer 170, and laptop computer 180 may be geographically remote and/or physically separated from each other.

Data server 130 represents a relatively powerful computer system that is made available to desktop computer 170, laptop computer 180, and/or mobile communication device 190 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art.

Given the relative advances in the state-of-the-art computer systems available today, it is anticipated that functions of data server 130 may be provided by many standard, readily available data servers. This may also include the deployment of multiple inter-connected and redundant data servers 130 to enhance the availability and reliability of the functions provided by data server 130. Depending on the desired size and relative power required for data server 130, storage area network (SAN) technology may also be deployed in certain preferred embodiments of the present invention. Additionally, various biometric and identification verification devices for identifying users and controlling access as well as creating and verifying digital signatures (i.e., electronic signature processing) may also be included.

Desktop computer 170 may be any type of computer system known to those skilled in the art that is capable of being configured for use with computer-based system 100 as described herein. It should be noted that no specific operating system or hardware platform is excluded and it is anticipated that many different hardware and software platforms may be configured to create computer 170. As previously explained in conjunction with data server 130, various hardware components and software components (not shown this FIG.) known to those skilled in the art may be used in conjunction with computer 170. It should be noted that in the most preferred embodiments of the present invention, desktop computer 170 is linked (via wired or wireless connection) to its own LAN or WAN and has access to one or more additional data servers (not shown this FIG.).

In addition as shown in FIG. 1, a telephone 160 may be used in conjunction with computer 170 to allow audio messages and alerts to be communicated to telephone 160. In this application, telephone 160 has been communicatively coupled to or otherwise interfaced with the standard telephone communication infrastructure associated with one or more users of computer-based system 100. Similarly, audio messages and various other communications and alerts may be communicated to mobile communication device 190 or other personal electronic device.

Similarly, laptop computer 180 may be any type of relatively lightweight portable computer system known to those skilled in the art that is capable of being configured for use with computer-based system 100 as described herein. This includes tablet computers (e.g., iPad®), pen-based computers and the like. Laptop computer 180 may also be configured to allow the transmission and reception of audio signals, messages, communications, and various types of alerts via server 130 and network 120.

Additionally, netbooks, tablets, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 is linked to its own LAN or WAN and has access to its own data server (not shown this FIG.).

In general, the communication between devices associated with data server 130 will be data associated with the creation and transmission of messages from a message originator to a message recipient. The users of desktop computer 170 and/or laptop computer 180 may be program administrators, managers, teachers, community members, parents and students who are seeking to access the relevant and valuable communications and messages. Additionally, various related entities such as local and regional governments, commercial enterprises, municipalities, and their employers and agents may also have access to one or more databases located on data server 130 via desktop computer 170 and/or laptop computer 180 to enable a broader and more robust messaging community.

It should be noted that while FIG. 1 shows only a single desktop computer 170 and a single laptop computer 180, it is anticipated that the most preferred embodiments of the present invention will comprise dozens or even hundreds of computers 170 and laptop computers 180. Each of these computers 170 and 180 will be configured to access data server 130 in an appropriately secure way so as to accomplish the specific objectives of the user of the desktop computer 170 or laptop computer 180.

For example, the service provider that controls the databases stored on data server 130 may utilize desktop computer 170 or laptop computer 180 or mobile communication device 190 to access data server 130 and create, update or otherwise modify a given database. An operator, located in a remote location, may use desktop computer 170 or laptop computer 180 to access data server 130 to retrieve information about the participants or persons and the various messages being created, sent, and accessed by the users of computer-based system 100.

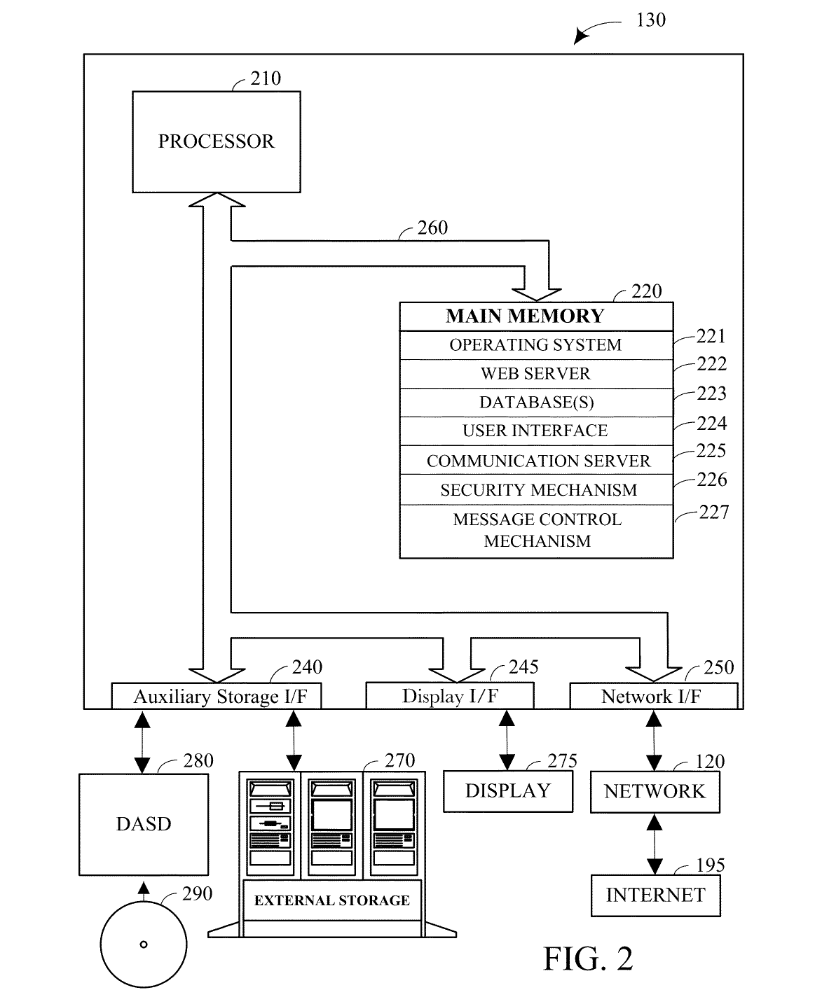

In the most preferred embodiments of the present invention, multiple desktop computers 170 and multiple laptop computers 180 will all be configured to communicate simultaneously with data server 130 and with each other via network 120. In addition, the most preferred embodiments of the present invention include a Software As A Service (“SAAS”) or Application Service Provider (ASP) environment where data server 130 may be operated as a clearinghouse in a hosted operation. In this fashion, multiple desktop computers 170 and laptop computers 180 will have access to data server 130 and the databases stored thereon via a global computer network such as Internet 195. Data server 130 is further described below in conjunction with FIG. 2 below.

An optional printer and an optional fax machine (not shown this FIG.) may also be deployed for various hard copy data output requirements and may be considered to be any standard peripheral devices used for transmitting or outputting paper-based documents, notes, transaction details, reports, etc. in conjunction with the various requests and transactions processed by computer-based system 100 (e.g., reports, communications, statistical analyses, automated letters, etc.) Finally, it should be noted that the optional printer and the optional fax machine are merely representative of the many types of peripherals that may be utilized in conjunction with computer-based system 100. It is anticipated that other similar peripheral devices will be deployed in the various preferred embodiment of the present invention and no such device is excluded by its omission in FIG. 1.

Mobile communication device 190 is representative of any type of wi-fi or Internet enabled mobile device or smartphone that may be communicatively coupled to computer-based system 100. This includes, for example, personal digital assistants (“PDAs”), Windows® mobile phone devices, Android® OS devices, Palm® OS devices, Pocket PC® devices, the Apple® iPod Touch®, the Apple® iPhone® and other various types of smartphones and portable communication devices. Those skilled in the art will recognize these various devices and others that are suitable for deployment as mobile communication device 190. While somewhat less powerful than computers 170 and 180, mobile communication device 190 may also be configured to wirelessly communicate with data server 130 via network 120 to send and retrieve tracking and messaging services related information to and from data server 130.

Given the standard functionality for devices that may be deployed as mobile communication device 190, this communication may be provided by a cell phone signal or wireless Internet connection (e.g. “wi-fi” or “wi-max”) or a Bluetooth® connection. One example of the use for mobile communication device 190 in the context of computer-based system 100 would be to send communications, messages or alerts to a parent of a student, alerting the parent of important information regarding the educational community and surrounding activities.

Those skilled in the art will recognize that FIG. 1 depicts a fairly standard “client/server” type communication arrangement where data server 130 is considered to be a server and computers 170 and 180 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that needs to be transferred from a database to the user of computer-based system 100.

Referring now to FIG. 2, data server 130 of FIG. 1 in accordance with a preferred embodiment of the present invention represents one of many commercially available computer systems such as a Linux®-based computer system, an IBM® compatible computer system, or a Macintosh® computer system. However, those skilled in the art will appreciate that the methods and system of the present invention apply equally to any computer system, regardless of the specific operating system and regardless of whether the computer system is a more traditional “mainframe” computer, a complicated multi-user computing device or a single user device such as a personal computer or workstation.

Data server 130 suitably comprises at least one Central Processing Unit (CPU) or processor 210, an auxiliary storage interface 240, a display interface 245, and a network interface 250, all of which are interconnected via a system bus 260. Note that various modifications, additions, or deletions may be made to data server 130 illustrated in FIG. 2 within the scope of embodiments of the present invention such as the addition of cache memory or other peripheral devices. FIG. 2 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 is configured to execute one or more software programs contained within main memory 220. Although data server 130 depicted in FIG. 2 contains only a single main processor 210 and a single system bus 260, it should be understood that the present invention applies equally to computer systems having multiple processors and multiple system buses. Similarly, although system bus 260 of the preferred embodiment is a typical hardwired, multi-drop bus, any connection means that supports bi-directional communication in a computer-related environment could be used.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a DVD or CD disk 290.

Display interface 245 is used to directly connect one or more displays 275 to data server 130. Display 275, which may be non-intelligent displays (e.g., “dumb”) terminals or fully programmable workstations, are used to provide system administrators and users the ability to communicate with data server 130. Note, however, that while display interface 245 is provided to support communication with one or more displays 275, computer data server 130 does not necessarily require a display 275, because all needed interaction with users and other processes may occur via network 120. Additionally, in certain preferred embodiments, data server 130 may have an integrated display 275.

Network interface 250 is used to connect data server 130 to network 120 and computer-based system 100, including computer 170 and computer 180 of FIG. 1. Network interface 250 broadly represents any suitable way to interconnect electronic devices, regardless of whether the network comprises present day analog and/or digital techniques or via some networking mechanism of the future. Network interface 250 preferably includes a combination of hardware and software that allows communications on network 120.

Software provided in conjunction network interface 250 preferably includes a communication manager that manages communication with other computer systems or other network devices via network 120 using a suitable network protocol. Many different network protocols can be used to implement a network. These protocols are specialized computer programs that allow computers to communicate across a network. TCP/IP (Transmission Control Protocol/Internet Protocol) is just one example of a suitable network protocol that may be used by the communication manager contained within network interface 250.

It is important to note that while the present invention has been (and will continue to be) described in the context of a fully functional computer system with certain application software, those skilled in the art will appreciate that the various software mechanisms of the present invention are capable of being distributed as a program product in conjunction with an article of manufacture comprising software stored on a computer readable storage medium in a variety of forms, and that the various preferred embodiments of the present invention applies equally regardless of the particular type or storage medium used to actually carry out the distribution. Examples of computer readable storage media include: non-transitory recordable type media such as DVD and CD ROMS disks (e.g., disk 290), and transmission type media such as digital and analog communication links, including wireless communication links.

Main memory 220 suitably contains an operating system 221, a web server 222, one or more databases 223, a user interface 224, a communication server 225, a security mechanism 226, and a message control mechanism 227. The term “memory” as used herein refers to any storage location in the virtual memory space of data server 130.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations. It should also be noted that any and all of the individual software mechanisms or components shown in main memory 220 might be combined in various forms and distributed as a stand-alone program product. Finally, it should be noted that additional software components, not shown in this figure, might also be included.

Operating system 221 includes the software that is used to operate and control data server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, Web server 222 provides access, including a user interface, to allow individuals and entities to interact with system 100 via graphical user interface 224, including communications sent via network 120 of FIG. 1.

Database 223 is representative of any suitable database known to those skilled in the art. In the most preferred embodiments of the present invention, database 223 is a Structured Query Language (SQL) compatible database file capable of storing information relative to various items that may be of interest to the users of computer-based system 100 of FIG. 1. In the most preferred embodiments of the present invention, database 223 will comprise a plurality of information that may be useful to an organization or individual that wants to provide messages for consumption by one or more message recipients, in conjunction with a preferred embodiment of computer-based system 100 of FIG. 1. Database 223 will also be used to store messages for delivery by communication server 225.

Graphical user interface 224 is a software component that provides the users of computer-based system 100 of FIG. 1 a means for interacting with the various components of computer-based system 100. In the most preferred embodiments of the present invention, graphical user interface 224 is a web browser based interface, accessible to the users of computer-based system 100 via any standard web browser from any computer that is connected to the Internet. Additional details on graphical user interface 224 are presented below. Additionally, at least one preferred embodiment of the present invention comprises a graphical user interface deployed on mobile communication device 190. In this embodiment, a graphical user interface may be offered via a native operating system “app” customized for mobile communication device 190 or via a web browser based interface deployed on mobile communication device 190 that provides via a connection to data server 130.

In at least one preferred embodiment of the present invention, database 223 of FIG. 2 will include a plurality of database records containing information about multiple schools and students (e.g., school location, student names, grades, dates and times of attendance, etc.) as well as information about teachers and parents (e.g., names and addresses, contact information, employment information, family information, etc.), and entries which are defined as specific situation/circumstances for various performance and event applications (e.g., club, sports, or other extracurricular participation involving a student or group of students) as well as information providing for tracking, analyzing and reporting message metrics for messages created and sent by the users of computer-based system 100.

In addition, the parameters and requirements for accessing and distributing various messages may also be stored and maintained in database 223. This includes detailed information about each user or group of users, including user preferences, permissions, and particularly the login or authentication credentials for each user's social media messaging platform accounts, etc. In this fashion, a user with access to database 223 will be provided with the capability of accessing multiple messages sent a variety of disparate sources in a single social media messaging platform.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 might also be physically stored in a location other than main memory 220. For example, database 223 may be stored on external storage device 270 or DASD 280 and coupled to data server 130 via auxiliary storage I/F 240. Additionally, while shown as a single database 223, those skilled in the art will recognize the database 223 may actually comprise a series of related databases, logically linked together. Depending on the specific application and design parameters, database 223 may take many different forms when implemented.

The most preferred embodiments of computer-based system 100 of FIG. 1 will typically include a communication server 225 in main memory 220. Communication server 225 may also be a distributed network of servers with multiple computers performing different functions and located in different locations around the world. Communication server 225 is an automated programmable system that is capable of generating one or more forms of messages or message events and will be configured to send the user's login or authentication credentials to the API server for one or more social media messaging platforms to enable the transmission of messages to the user's social media messaging account. For example, communication server 225 may be configured to send electronic messages to a user's Facebook® account, using the credentials previously stored in database 223 by the user. Communication server 225 may also be configured to generate hard copy messages (e.g., mail merge letters, greeting cards, memos, etc.) that are then sent via standard U.S. Postal Service or some type of commercial message delivery service.

However, in the most preferred embodiments of the present invention, communication server 225 will be configured to deliver messages to the message recipient's social media messaging platforms based on each message recipient's preferences. Each message recipient, as an authorized user of computer-based system 100, will have an account and their account information will be stored in database 223 of FIG. 2. It should be noted that the output from communication server 225 might be determined based on preferences maintained in conjunction with each message recipient's account.

Message recipients may specify their messages selection and content delivery preferences via user interface 224. For example, if a message recipient prefers to receive a customized message via email, then communication server 225 will transmit the customized message to the message recipient via email. Alternatively, a blind person may request their customized message in an audio format. By using various text to speech conversion technologies, their customized message will be converted to an audio signal and delivered via telephone 160 of FIG. 1 or as an audio stream delivered via an application on smartphone 190 of FIG. 1 or as an audio file attached to an email. Additionally, each message recipient will be able to specify which social media messaging platform or platforms they wish to authorize to receive communications from message originators.

Communication server 225 can also send push notifications to third party servers, such as the Apple® Push Notification Service or Google® Cloud Messaging for Android®, which then deliver push notifications to smart phones using server-push technology in which a communication between a communication server and a user is initiated by the communication server rather than the user.

Messages may also be translated so that message recipients can view the message in a language other than the default language. Communication server 225 retrieves the language setting of the mobile device through an HTTP request header and uses the language of the language setting as the target language, or if the message recipient has stored a language preference in database 223 then communication server 225 uses the language preference in database 223, which the message recipient has identified as the target language for message delivery.

Additionally, communication server 225 may be configured to generate a facsimile message by utilizing a fax server and a facsimile modem (not shown this FIG.) that is deployed in conjunction with data server 130 of FIG. 2. Communication server 225 is also capable of being configured and used to send and receive various electronic status messages (e.g. audio and video alerts) and updates to data server 130 and between computers 170, 180, and/or mobile communication device 190 of FIG. 1, as may be necessary to enhance the overall process of completing activities related to the provision of customized communication services as described herein.

In addition, most preferred embodiments of the present invention would include a security and/or encryption mechanism 226 for verifying access to the data and information contained in and transmitted to and from data server 130. Security mechanism 226 may be incorporated into operating system 221 and/or web server 222. Additionally, security mechanism 226 may also provide encryption capabilities for other components of computer-based system for providing customizable communication 100 of FIG. 1, thereby enhancing the robustness of computer-based system for providing customizable communication 100 of FIG. 1. Security mechanism 226 is most preferably configured to protect the integrity and security of the information transmitted via network 120 of FIG. 1.

Further, depending on the type and quantity of information stored in database 223 and accessed by graphical user interface 224, security mechanism 226 may provide different levels of security and/or encryption for different computer systems 170 and 180 of FIG. 1 and the information stored in database 223. The level and type of security measures applied by security mechanism 226 may be determined by the identity of the message recipient and/or the nature of a given request and/or response. In some preferred embodiments of the present invention, security mechanism 226 may be contained in or implemented in conjunction with certain hardware components (not shown this FIG.) such as hardware-based firewalls, switches, dongles, and the like.

Message control mechanism 227 is a software program or mechanism that uses the information stored in database(s) 223 to facilitate the flow of messages between message originators and message consumers via social media messaging platforms in an appropriate and controlled fashion. Message control mechanism 227 will access the data contained in database(s) 223 and use the data to control the flow of messages for each individual or group, using various social media messaging platforms such as Twitter®, Facebook®, Tumblr®, Instagram®, Google Chat®, Google-F®, etc. In the most preferred embodiments of the present invention, message control mechanism 227 acts as an intermediary between message originators and message recipients and as a message aggregator.

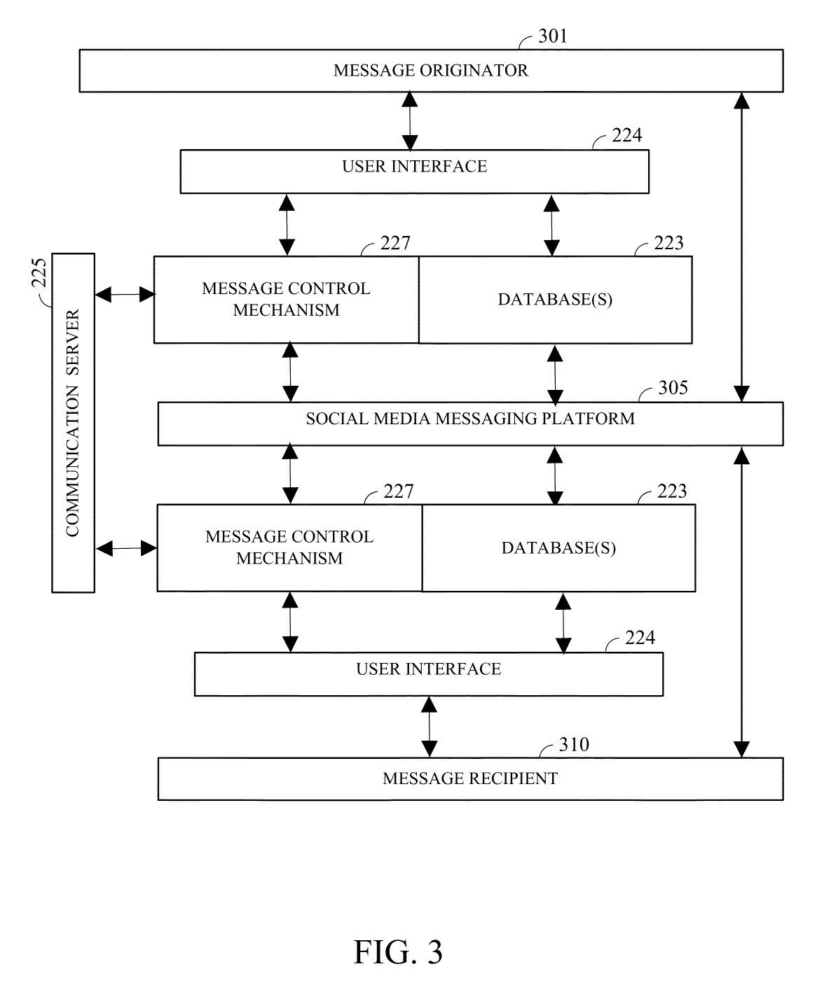

For example, messages sent by multiple message originators may be received by message control mechanism 227 and sent to a single social media messaging platform, allowing the message recipient to receive all messages via their existing social media messaging platform. Since the message originator does not need to know the social media platform or the message recipient's account information, the message can be delivered without the message originator accessing any social media message platform information. This allows for the sending of messages from a message originator to a message recipient, without the message originator having any knowledge about the message recipient's social media messaging platform account information. In the most preferred embodiments of the present invention, message control mechanism 227 is included in a larger software application that can be used to create a web portal for organizations that wish to establish a robust communication environment for their users. This includes the establishment of a web portal and the deployment of software applications for organization members to use in a structured messaging environment. Additional information about message control mechanism 227 is presented below in conjunction with FIG. 3.

In the most preferred embodiments of the present invention, the various components of computer-based system 100 of FIG. 1 are able to communicate using multiple communications protocols and systems (e.g., Voice over IP or “VoIP”, Plain Old Telephone Service or “POTS”, etc.). Those skilled in the art will recognize that the communication protocols used herein may be readily adapted and configured to allow for the rapid and efficient transmission and receipt of data by and between the various components of system 100 of FIG. 1. This would also include the ability to control and customize the input and output of system 100 of FIG. 1 for integration with other systems. While a specific exemplary embodiment of a suitable server 130 has been provided above, those skilled in the art will recognize that many other suitable computers (with more or fewer features) may be substituted for the specific example provided herein without departing from the spirit and scope of the present invention.

Referring now to FIG. 2 and FIG. 3, one or more message originators 300 will interact with system 100 of FIG. 1 via user interface 224. User interface 224 may be a web browser user interface accessed by any standard web browser on desktop computer 170, laptop computer 180 or a mobile web browser on mobile communication device 190. Alternatively, message originator 300 may access user interface 224 using a native application or “app” on mobile communication device 190. In any case, by accessing user interface 224, message originator 300 can input and modify the data contained in database(s) 223. Message originator 300 can also interact with user interface 224 to create one or more messages that will be received by one or more message recipients 310.

Similarly, one or more message recipients 310 will interact with system 100 of FIG. 1 via user interface 224. Each message recipient 310 will store information in database 223 that will allow message control mechanism 227 to receive messages from communication server 225 and then interact and communicate with one or more social media messaging platforms 305 to send messages from message originator 301 to message recipient 310. For example, the login credentials for the social media messaging platforms 305 used by message recipient 310 are stored in database 223 and message control mechanism 227 will access a set of stored authentication credentials for the selected social media messaging platform and transmit the message to the message recipient without revealing any information about the message recipient's social media messaging platform user account or authentication credentials.

In the most preferred embodiments of the present invention, message control mechanism 227 acts as an intermediation mechanism, providing for the controlled flow of messages from message originator 301 to message recipient 310 without exposing any of the social media account access information of message recipient 310. If message recipient has authorized social media messaging platform 305 to send messages from message originator 310 via a social media messaging platform 305, message control mechanism 227 will route messages generated by communication server 225 from message originator 301 to message recipient 310 via social media messaging platform 305. In this fashion, a teacher has the ability to send Facebook® messages to a student without having any knowledge of the student's Facebook® account. This will isolate the student and the teacher from the other's Facebook® account and Facebook® feed, while enabling the student and the teacher to use Facebook® for approved communication.

Additionally, since all of the messages from message originator 301 to message recipient 310 are transmitted via message control mechanism 227, the administrators of system 100 can monitor the frequency, content, and appropriateness of the messages sent from message originator 301 to message recipient 310. This may reduce or significantly reduce the probability of inappropriate messages being sent from message originator 301 to message recipient 310 (e.g., inappropriate teacher-student communications). This is especially relevant since artificial intelligence algorithms and word screening protocols can be used to intercept any inappropriate or improper message content, prior to the message being sent. A message may be deleted, sequestered for further review, or edited by system 100 or an administrator of system 100.

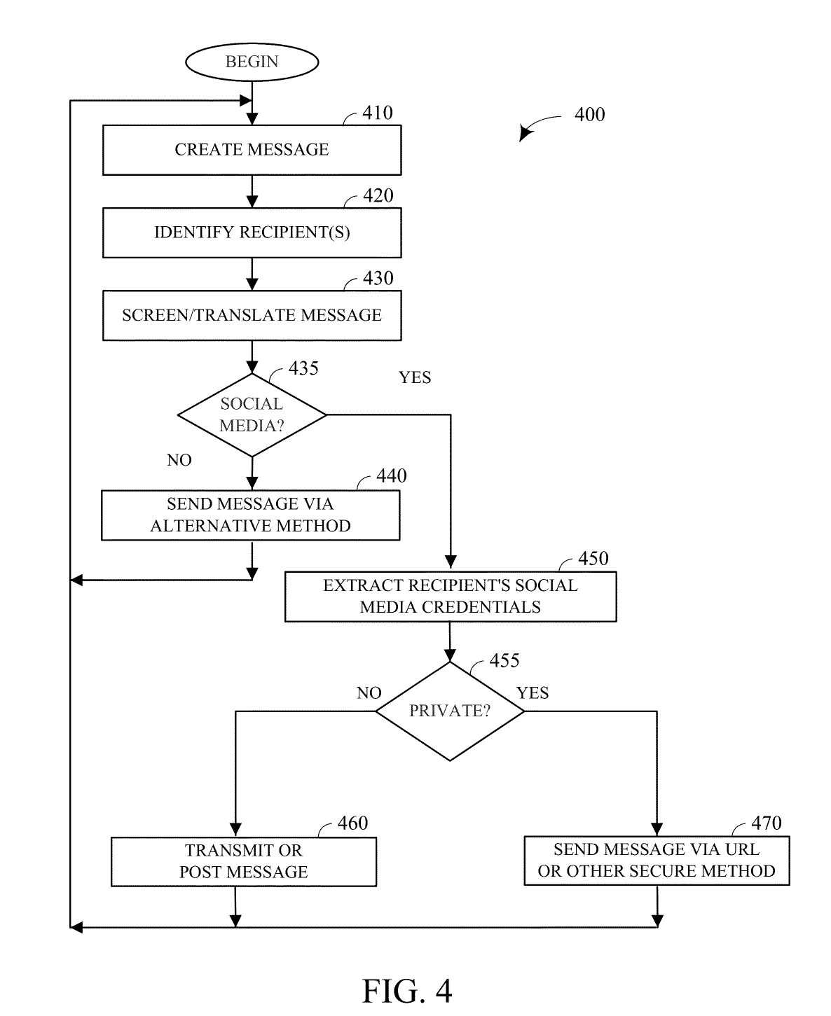

Referring now to FIG. 4, an overall process and method 400 for creating and sending messages using social media messaging platforms in accordance with a preferred embodiment of the present invention is shown. In the most preferred embodiments of the present invention, method 400 is a computer-implemented method used in conjunction with the hardware and software described in conjunction with FIG. 1, FIG. 2, and FIG. 3.

As shown in FIG. 4, the first step is for the message originator to create a message (step 410) and identify the intended recipient(s) (step 420). With the message content created, system 100 will examine the message and screen the message (for appropriate and/or restricted content) and translate the message, if necessary (step 430). This may include additional steps such as checking the message content against a key word index, evaluating the relationship between the message originator and the intended message recipients, etc.

For purposes of this embodiment, “translate” means to translate the message from one language to another language or to translate the message from one form to another (e.g., from an audio message to a text format, etc.). For purposes of this embodiment, “screen” means to edit the message, reject the message, or “flag” the message for programmatic review by system 100 or manual review by an administrative user.

Next, computer-based system 100 will evaluate whether or not the message recipients have identified a social media messaging platform and provided authentication credentials for delivery of messages (step 435). This step may be evaluated on a recipient-by-recipient basis and the result may be different for different message recipients. It is important to note that while a customized message may be initially identified, the final selection of the component messages that comprise the aggregated messages may be performed on an automated basis or an “ad hoc” basis by the message recipient. If the message recipient has not provided for message delivery via social media messaging platforms (step 435=“NO”), then system 100 will select an alternative delivery methodology for delivering the message to the intended recipient(s).

If, however, the intended recipient(s) have identified social media messaging as a preferred delivery method, and provided social media messaging platform authentication credentials (step 435=“YES”), then system 100 will extract the authentication credentials from database 223 (step 450) and deliver the message via the identified social media messaging platform. In this case, system 100 will also check the message to see if it has been identified as a private message (step 455). If the message is a public message (step 455=“NO”), then system 100 will communicate with the social media message platform to transmit or post the message to the message recipient's account (step 460). If, however, the message has been identified as a private message (step 455=“YES”), then system 100 will deliver the message in a secure fashion. In the most preferred embodiments of the present invention, this will entail sending the message recipient a private message with a hyperlink to a URL where the private message content can be accessed by the message recipient.

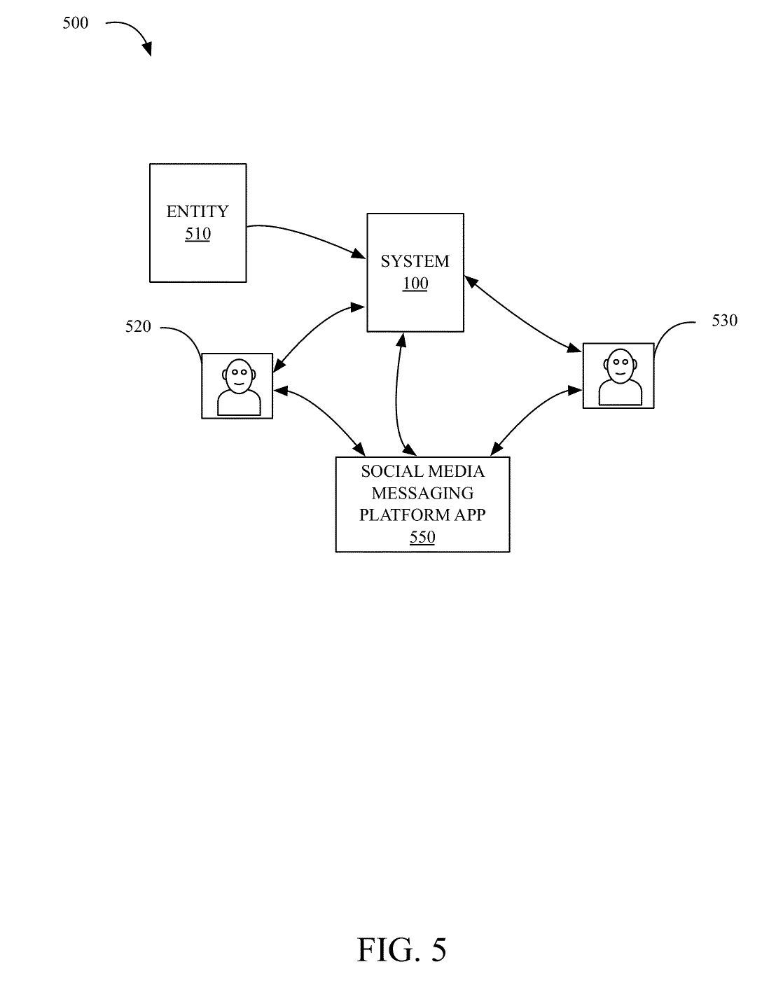

Referring now to FIG. 5, a block diagram 500 can be used to model and further describe the flow of communications for entities using a computer-based system for controlling and monitoring the flow of communication in accordance with a preferred exemplary embodiment of the present invention. As shown in FIG. 5, a school or school district 510 can communicate with system 100 and social media messaging platform app 550 to send various types of information to system 100 that can be incorporate into messages for one or more message recipients.

For example, school 510 may send ad hoc messages regarding school closures, school announcements, parent surveys, etc. to system 100. Additionally, school 510 may send automatic messages that are generated by a computer system owned and/or operated by school 510. Examples of these automated messages would include attendance data and reports, lunch money account balances, grade and assignment reports, etc. As authorized, all of the data provided by school 510 may be incorporated into one or more messages by a teacher or administrator 520 (as a message originator) and transmitted to a parent or student 530 (as a message recipient).

Teacher or administrator 520 may communicate directly with system 100 via a computer 170 or 180, via user interface 224, a web browser, or via an app installed on a mobile communication device 190. Further, since teacher or administrator 520 also has a user account with social media messaging platform app 550, teacher or administrator 520 can also communicate directly with the social media messaging platform (e.g., Facebook®). System 100 will interface and communicate with social media messaging platform app 550 to forward messages to parent or student 530 as appropriate. This will allow teacher or administrator 520 to send social media messages to the social media account of parent or student 530 without ever having any information about their social media account.

Similarly, parent or student 530 may communicate directly with system 100 via a computer 170 or 180, via user interface 224, a web browser, or via an app installed on a mobile communication device 190. Further, since parent or student 530 also has a user account with social media messaging platform app 520, parent or student 530 can also communicate directly with the social media messaging platform (e.g., Facebook®). System 100 will interface and communicate with social media messaging platform app 550 to forward messages to teacher or administrator 520 as appropriate. This will allow parent or student 530 to send social media messages to the social media account of teacher or administrator 520 without ever having any information about their social media account.

When accessing system 100, parent or student 530 will be able to view consolidated media rich Facebook-like views displaying information specific to parent or student 530. For example, they may view automated notifications (attendance, grade drop, low cafeteria balance, overdue library books, etc.), update posts from teacher or administrator 520, automatic assignment post from grade book, general messages sent from school 510, etc. In addition, they will be able to access various media including pictures, videos, documents, slide presentations, etc. that have provided in one or more messages.

When accessing the social media application (e.g., Facebook®) associated with social media messaging platform app 550, parent or student 530 will see public information included with their news feed directly within the Facebook® user interface. For private information, system 100 will notify parent or student 530 via private Facebook® messages and provide parent or student 530 with information on how to securely access the private information.

With the framework and overall concept for using system 100 of FIG. 1 to create, deliver, monitor, and control the flow of messages from message originators to message recipients, additional implementation details and environmental application considerations may be presented by referring to FIG. 1, FIG. 2, FIG. 3, FIG. 4, and FIG. 5.

For most organizations, system 100 will be deployed as part of an overall effort to provide robust communication and messaging tools for the organization's constituents. Since most organizations don't have the resources and expertise necessary to deploy and operate system 100 on their own, the organization will typically work with a third party service provider to create and maintain system 100. This generally takes place in the context of a cloud-based offering with a subscription model where the organization will pay the third party service provider for using system 100.

Initially, the organization will create a user account for each participant that will be a message originator, a message recipient, and/or an administrative user of system 100. This will occur in the context of establishing a web portal and a web portal account for each user of system 100. Each user is then provided with authentication credentials so that the user can access their web portal account. Data associated with each user is stored in database 223 of FIG. 2, and the user can access the web portal account information via user interface 224 of FIG. 2 to retrieve and display data from database 223 after system 100 has authenticated the consumer, typically via security mechanism 226.

After a user has been authenticated, system 100 the user can establish account preferences (e.g., most preferred means for receiving messages, devices associated with the user, etc.). System 100 will also display data related to the messages sent and received by the user. This typically includes summaries of messages which have been sent to the user in their role as a message recipient (e.g., whether or not a received message has been read by the message recipient, the date which a message was sent to the message recipient, the name of the message originator for each message, the social media messaging platform through which a certain message was sent, the level of urgency for a message, the details of a message, etc.).

In at least some preferred embodiments of the present invention, the details of a message are displayed to the message recipient after the message recipient has selected the summary of a message. System 100 will also provide an interface so that the message recipient can establish a schedule for message delivery to each of the message recipient's registered devices (e.g., mobile communication device 190, home telephone, web-based email account, etc.). For example, after accessing system 100 via user interface 224, the user may instruct system 100 to send messages to his or her cell phone from 9 AM to 5 PM on Monday through Saturday but only send messages to his or her home phone from 7 PM to 9 PM on Monday through Saturday.

Once an account has been established for each user of system 100, an organization can use system 100 to provide a robust messaging and communication environment for the organization's constituency. As user become affiliated or unaffiliated with the sponsoring organization, user account will be added or deleted from database 223. In order to provide additional contextual examples, the use of system 100 in an educational environment will be discussed. However, those skilled in the art will recognize that the various embodiments described are equally application to a wide variety of other organizations (e.g., businesses, municipalities, faith organization, etc.). Similarly, even though the examples presented below identify Facebook® as the social media messaging platform, those skilled in the art will recognize that the concepts are directly transferable to other social media messaging platforms as well.

For a typical school environment, an administrator such as the principal of a school creates an account via a social media web app such as a Facebook® web app for the school. Alternatively, the principal of the school contracts with a third party service provider to create the social media web app and provide communication services to the principal's organization, which is a school.

The third party service provider or the school may then encourage their constituents (e.g., teachers, parents, students, staff) to install the Facebook® web app by sending messages to the constituents containing a URL to the Facebook® web app, or by placing a badge on a website or Facebook® page stating that constituents can install a Facebook® web app to receive personalized communications from the school.

In the context of Facebook® once the Facebook® web app is available for use, constituents will have the ability to install and login to the Facebook® web app (see http://developers.facebook.com/docs/guides/canvas/), thereby initiating third party access to their Facebook® account and related data. During installation of the Facebook® web app, the Facebook® web app will request permission from the user to engage in various activities on the user's behalf. This includes permission to post messages, permission to see friends, permission to access the user's email address, permission to read the user's inbox, permission to access all of the user's posts in the consumer's news feed and permission to search the consumer's news feeds, permission to chat with the user, permission to add and edit calendar events, etc.

In some preferred embodiments of the present invention, a message recipient may set the settings of their Facebook® account so that all of its posts are made public and, if so, then system 100 does not send private information to a message recipient's Facebook® account until the message recipient has altered their Facebook® account settings so that all posts are private posts or posts from that particular message originator are private posts.

In other preferred embodiments of the present invention, an organization which uses system 100 to send messages will upload a database containing the names of students attending the organization, the names of the parents of the students, and the identity or status of each potential user (e.g., “parent,” “student,” etc.). A student who attempts to login to the Facebook® web account will first need to confirm to system 100 that the student has received permission to access system 100, which can be accomplished by allowing the student access a web portal account and send a request for access to the Facebook® web app.

After the student has requested permission to access the Facebook® web app, system 100 will use the contact information stored in database 223 and send a message to the parent or guardian of the student, requesting that the parents grant permission for the student to access system 100. Depending on the parent's identified communication preferences, system 100 will send a text message, an email, or initiate a phone call to the parent. In the case of a phone call, system 100 will place a phone call to the parent's cell phone or home phone, and play a pre-recorded message to the parent which explains the features of the Facebook® web app and requests that the parent give permission by logging in to the parent's web portal account or by pressing a button on the keypad (e.g., “to grant your student permission to access the system press the number ‘1’ now”).

Alternatively, when a student sends a request to system 100 that the student be granted access to system 100, system 100 may automatically generate and send an electronic “permission slip” to the guardians who are associated with the student as listed in database 223. The electronic permission slip is a message which allows the guardian to grant permission for the student to access system 100 using electronic means for a minor such as a student, such as by actually signing a digital copy of the permission slip on a tablet, typing in the guardian's name, or checking a box to give consent. If the student's parents are divorced or separated with joint custody, then system 100 will send a permission slip to each parent and require consent from one or both parents, depending on the desired parameters for approval.

The means of acknowledging consent for the student to access system 100 via a permission slip may be as simple as “press a yes button to signal you agree to the terms of use” or it may include an explanation of the terms of use and how the school and system 100 will eliminate or decrease any risks associated with using the Facebook® web app. For example, system 100 may be configured to send each parent a duplicate copy of any Facebook® messages sent to the student by a teacher or administrator.

With system 100 in place, and with administrators, teachers, students, staff and students having established accounts, a robust messaging environment can be used to send and receive messages in the user community. For example, teachers can send private or public messages to system 100 and system 100 will utilize the Facebook® messaging API and message recipient authentication credentials stored in database 223 to relay those messages to a Facebook® web app so that the messages will be posted to the designated message recipient's Facebook® wall (in the case of a public message) or sent as a private Facebook® message to the designated message recipient(s).

In the most preferred embodiments of the present invention, public messages are sent by message originators from a mobile app accessed via mobile communication device 190. Alternative embodiments include creating and sending public messages through a web portal offered by web server 222 and accessed via user interface 224. The messages are sent from system 100 to Facebook® or any other social media messaging platform where they can be viewed by the designated message recipient(s). Messages sent by this method can be screened and monitored by system 100 or copies of the messages can be sent to the administrators.

In some preferred embodiments of the present invention, system 100 uses filters to search for and automatically eliminate certain words or phrases (e.g., profanity or “bullying words”, words with sexual connotations, etc.) as well as email addresses, phone numbers, and social media addresses. In other embodiments, system 100 simply forwards a copy of any flagged message to a human administrator who reviews the message for inappropriate content and edits or approves the messages before system 100 sends the message to the Facebook® web app for posting. In some embodiments, the “public” information is posted to a private group such as a group of users who are parents of students in the same fifth grade class or same freshman class or a group of residents who live in the same geographical area. In other embodiments, the “public” information is posted to a Facebook® account that is configured so that any posts to that Facebook® account are completely visible to the public.

Consumers, as used herein, are users of any social media platform. When consumers, such as Facebook® users, comment on a post, the comment may be transmitted to the Facebook® web app if the Facebook® web app has received permission from the consumer to view comments made by the consumer (assuming that the Facebook® web app has received permission to view comments) and then the Facebook® web app sends that information to system 100. System 100 can then send that information to the administrator who posted the content, to a mobile app installed by the administrator, or the web portal account of that administrator.

The administrator can then respond to the comment and the response is sent to the Facebook® web app which then posts that comment a comment to that “thread”. When a consumer makes a connection to a post such as clicking on the “Like” button or a “+1” button, that information may be sent to the Facebook® web app which relays the information to system 100, and system 100 stores that information and displays that information as part of a statistic. In some preferred embodiments of the present invention, system 100 sends a copy of the message or a compilation of a plurality of messages to an administrator other than the administrator who originally sent the message so as to provide for additional oversight.

In some preferred embodiments of the present invention, the user interface used to compose messages will include an icon or other interface element that allows a message originator to select a privacy setting for sending a private message to a message recipient's social media account. The interface element can be displayed via user interface 224 or via a mobile app on mobile communication device 190. When the message originator has selected the private setting and then sends a message, the message is sent to the message recipient and will be labeled as a private message. The private messages is stored in database 223 and made accessible at a web interface to authenticated message recipient only. Alternatively, some message recipient may choose to configure their web portal account or their Facebook® account so that any messages sent to their Facebook® account from the message originator's organization, such as from a certain school, will also be handled as private messages.

When sending a message, system 100 checks database 223 to determine whether the message recipient is associated with mandatory private messages, and if so, system 100 will send a private message to that message recipient. In some embodiments, system 100 is configured so that any message that is sent to a single user is sent as a private message, even if the administrator selects the setting as a public message. In this fashion, it is less likely that private messages will inadvertently be sent to an unauthorized message recipient.

In some embodiments of the present invention, a message originator will want to send a private message to a single message recipient. For example, a teacher who sends a message stating that “Your daughter Suzie is struggling with fractions but is receiving one-on-one tutoring” would likely send the message only to Suzie's parents. In that scenario, if the private setting for Suzie's parents has been selected by Suzie's parents, the school, or system 100, then the private message would be stored in a database with a unique identifier. A unique URL would be sent to the parent's Facebook® account, and when the parent used a web browser to access the unique URL while being logged in to the consumer's web portal for the web portal account on system 100, then system 100 would display the private message to the parent via the web portal for the web portal account or by displaying the private message in a mobile app connected to system 100 and installed on the consumer's mobile communication device 190.

In some preferred embodiments of the present invention, if the message recipient has installed a mobile app connected to system 100 on their mobile communication device 190 and the message recipient is viewing their Facebook® account on mobile device 190 and clicks on a link in a Facebook® message to a private message sent by system 100, then system 100 will send the private message to the mobile app on mobile communication device 190. Additionally, system 100 will request that the mobile device display the private message as a push notification.

Alternatively, a unique URL may be sent to the message recipient's Facebook® account, and when the message recipient selects the unique URL, all messages sent to message recipient's Facebook® account will be posted to a private location, such as the message recipient's web portal account or mobile app connected to system 100 and installed on the message recipient's mobile communication device 190. System 100 will then send a message to the message recipient's Facebook® account or through some other channel containing a URL such that when the message recipient clicks on the URL, the message recipient will be shown the private message or be presented a login interface to the message recipient's web portal account so that system 100 can display the private message to the message recipient after the message recipient has been authenticated to the consumer's web portal.

In some preferred embodiments of the present invention, the message originator will select one or more message recipients from a list of potential message recipients by accessing user interface 224, including message recipients who have elected to receive private messages. After the message originator has selected one or more message recipients, system 100 will provide a visual indicator associated with each message recipient that has been selected to receive private messages. The visual indicator may take the form of a check mark or “flag” displayed next to the name, a bold or italicized display font for the message recipient's name, or some other method to highlight that the name has been selected, and system 100 will send private messages to the message recipient's social media account or other designated device or account.

By marking the selected message recipients with a flag or some other means, the message originator who is composing a message may decide whether or not to include confidential content in a message if the message will only be sent as a private message to the message recipient. In some instances, the message recipient may set the settings for their Facebook® account or the settings for its installation of its Facebook® web app so that all posted messages are private messages.

When the Facebook® web app detects that the message recipient has configured its Facebook® settings so that all Facebook® messages or any Facebook® messages from the Facebook® web app are made public, then in the most preferred embodiments of the present invention, the Facebook® web app would then only send links to that message recipient and not send actual confidential content to the inbox of that message recipient's Facebook® account.

In some preferred embodiments of the present invention, a lower level administrator such as a administrative assistant is not authorized to send an unapproved message to a message recipient's Facebook® account unless the message has been approved by a higher-ranking administrator. These multi-level message sending permissions are indicated by a role-based designation associated with each potential message originator and will be managed and enforced by security mechanism 226.

In other preferred embodiments of the present invention, a message originator will be provided with a list of pre-approved messages that are stored in database 223. When an message originator selects a message from the list of preapproved messages and selects at least one message recipient, then the message will incorporate merge tags to personalize the message such as displaying the name of the message recipient or the message recipient's student within the body of the message.

If the message originator selects to send the message as a private message, then system 100 will tag the message as a private message and deliver the message to a message queue associated with communication server 225. The message will then be automatically sent to the message recipient based on the message's various delivery settings established by the message originator and the message recipient. Alternatively, if the message originator composes a unique message (e.g., not a preapproved message), the message will not be automatically queued for delivery but will be sent through an automatic filter or to an administrator or both. If the message is sent to an administrator, then the administrator may need to approve the message before the message can be sent to the message queue and scheduled for delivery to the message recipient.

In some preferred embodiments of the present invention, the messages are translated to different languages using human translation or automatic translation. If the message is translated using automatic translation, the message originator selects the initial language of the message and the target language of the message and system 100 submits a translation request to a translation engine. Once the translation engine returns the translated message, system 100 uses that translation of the message to message recipients who have either requested that messages be sent to them in that language or where a third party, such as an administrator, has determined that messages should be sent in that language to the message recipient.

In addition to using Facebook®, other social media messaging platforms may be used in conjunction with system 100. For example, Twitter® is a very popular social media messaging platform. In at least one preferred embodiment of the present invention, an organization such as a school district may use system 100 to send “tweets” via a proxy Twitter® account. In this case, the proxy Twitter® account will be used to represent the school district as a message originator and the settings for the proxy Twitter® account will be configured so that any messages sent from the proxy Twitter® account and any messages sent to the proxy Twitter®account will be shared with system 100. In this fashion, system 100 can monitor the messages and monitor if the proxy Twitter® account's settings are changed. The authorized representatives of the school district will create messages and, as the message originator, may directly use the proxy Twitter® account to send and receive messages.

If an administrator at an organization configures system 100 to allow administrators or message originator to directly use a proxy Twitter® account, then system 100 will send the Twitter® handle for the proxy Twitter® account and the login password for the proxy Twitter® account to the message originator. Then system 100, will most preferably configure the proxy Twitter® account so that there are at least two levels of users: an administrator level with full send rights and full rights to configure the Twitter® account, and a message originator level with full send rights but without full rights to alter the configuration of the Twitter® account. In that embodiment, a teacher could use the proxy Twitter® account as a message originator to send messages but could not alter the configuration of the Twitter® account so that it would stop sending copies of the sent messages and received messages to system 100.

In some preferred embodiments of the present invention, an administrator cannot access the Twitter® account or send messages from the proxy Twitter® account unless the administrator has logged into an administrator's web portal account provided by system 100. Once the administrator has logged into system 100 via their web portal account or via software which has been downloaded to mobile communication device 190, system 100 will then log into the proxy Twitter® account and either allow the message originator to directly access and use the proxy Twitter® account or allow the message originator to use and display the proxy Twitter® account within a web portal interface provided by system 100 or within an app that has been installed on the message originator's mobile communication device 190. After logging into the administrators' web portal, system 100 displays a mirror image of the proxy Twitter® account by making and displaying 1) a copy of messages that had been sent from the proxy Twitter® account and 2) messages that had been sent to the proxy Twitter® account.

In some preferred embodiments of the present invention, an administrator configures an existing Twitter® account by requesting that Twitter® grant access to system 100 so that all of the messages sent to that Twitter® account and sent from that Twitter® account will be also sent to system 100. Twitter® may then redirect the consumer to a login page so that the administrator can authenticate that the administrator is authorized to configure that account. After the administrator has been authenticated, Twitter® may issue a token to the administrator that may be shared with system 100. System 100 may then use the token to authenticate to Twitter® that system 100 is authorized to receive copies of messages that are sent and received from the Twitter® account. When using a social media messaging platform like Twitter®, it is not necessary for the message originator to have a personal Twitter® app. The message originator could establish a proxy Twitter® account that represents the message originator's school or school district, providing “tweets” on behalf of that entity. Similarly, the message originator could use a proxy Twitter® account to create a class Twitter® feed and distribute public information via Twitter®.

Once the proxy Twitter® account has been created, some message recipients may want to follow the proxy Twitter® account. System 100 can be configured to send messages to potential message recipients, inviting the message recipients to follow at least one proxy Twitter® account, such as a proxy Twitter® account for the math teacher of the message recipient's seventh grade student. The proxy Twitter® account may also be listed in a community feed mobile app, a mobile app configured communicate with system 100 and an organization such as the consumer's student's school, a button on a social media account such as a school Facebook® page, a button on a website such as a teacher's website, and on Twitter®.

Potential message recipients are sent a message, such as an SMS message or a Facebook® message, and the message instructs the message recipients how to follow a Twitter® feed. The owner of the Twitter® feed then can send messages or a private link to other messages. If a message recipient is following a certain account, then posts to that account result in messages that are sent to that message recipient. System 100 sends private messages by sending direct messages via a proxy Twitter® account. However, in some preferred embodiments of the present invention, the message recipients would need to inform system 100 via a configuration page or some other means the name of the message recipient's Twitter® handle. System 100 can send a private message by including the message recipient's Twitter® handle in the body of a direct message and sending a direct message to a message recipient. System 100 can send a private message via Twitter® by addressing the message to the consumer's Twitter® handle.

The most preferred embodiments of the present invention provide for a more secure and controlled way for communications to be sent from students to teachers via Facebook® or any other social media application. The messages are sent from the social media application directly to system 100, where they can be screened and monitored by system 100 or school administration for appropriate usage. The messages are then sent to the teacher app via system 100, including a mobile app installed on the teacher's mobile communication device 190. In this fashion, all communications from the student to the teacher can be monitored and delivered without the student ever having direct access to the teacher's Facebook® account. The student and the teacher do not need to be Facebook® “friends” in order to use to communicate. System 100 acts as an intermediary or “bridge” between the student and the teacher and allow for communication of messages without exposing Facebook® user account information for the teacher to the student or for the student to the teacher. Additionally, in some preferred embodiments of the present invention, administrators of system 100 have the ability to allow or disallow messages from students to teachers, on an individual basis or as a whole. Further, teachers will be able to decide whether they want to receive messages from students in general or only as responses to teachers' messages that have been sent to the students. In this fashion, additional control over student-teacher message interaction can be maintained at the desired level.

In alternative preferred embodiments of the present invention, message recipients and message originators are grouped into organizations. For example, a group of residents in the same neighborhood can be organized into a neighborhood organization, service organization, church groups, etc. For schools, other organizations may be established based on classroom or class (such as the sophomore class) at a school, membership in a team or similar extracurricular activity group. In some preferred embodiments of the present invention, members of an organization can see which individuals are also members of the organization. In this fashion, group messages and group responses may be used to effectively increase the ability of the organization members to communicate with each other.

In at least some preferred embodiments of the present invention, students can look up other students in a directory or they can be assigned as members of the same group based on their organization, such as a member of Mrs. Smith's 10^{th} grade English class and a member of the local Neighborhood Watch. Then, any member in that group can send a message through the Facebook® web app to that single member or two or more members of the group. A copy of any consumer-to-consumer messages may be sent to the administrator or, as previously described above; one or more automatic algorithms may flag or automatically edit any messages that have questionable content. The message may be posted to a Facebook® page if the setting s for that have been activated. The message may be posted to the student's wall if the student has installed the Facebook® web app. Messages may also be sent as private messages and a copy of messages may be sent to administrators or to parents.

In at least one preferred embodiment of the present invention, potential message recipients are presented with a configuration page via user interface 224 and the configuration page displays a list of organizations which the message recipient may follow or subscribe to. Organizations would include classes, teams, or organizations such as a school or school district. When the message recipient selects certain organizations, system 100 is notified of the message recipient's preferences. Then according to the preferences, system 100 will send messages to the message recipient based on the message recipient's preferences. For example, if a message recipient configures system 100 so that it selects the option to follow Mrs. Gruss's class, then the message recipient will begin to receive posts from Mrs. Gruss when she sends a message using the social media option.

When system 100 posts multiple messages from multiple message originators, it may create redundant messages in the web portal, a separate parent app, a separate community feed app, and/or the Facebook® web, and there may be some circumstances where it is beneficial to allow the redundant messages. But in other circumstances, some message recipients may be annoyed by receiving redundant messages. Accordingly, the most preferred embodiments of the present invention will include a feedback mechanism in message control mechanism 227 that is configured to ascertain whether or not a message recipient has accessed the message by scrolling through the message, clicking on the message, clicking on a picture embedded in the message, or, by some other means, clicking on a button stating that the message recipient has read the message. If system 100 determines that a message recipient has viewed a message, it will then delete any redundant messages from the message queue so as to avoid sending multiple versions of the same message to the message recipient.

For example, if system 100 determines that the consumer has read a message from within a mobile app installed on a mobile communication device 190, then system 100 will delete that message from the consumer's web portal account or mark that message as read in the consumer's web portal account. In some embodiments, system 100 can delete a message that has been posted to a consumer's Facebook® wall via the Facebook® web app when system 100 receives feedback that the consumer has viewed that same message through a different channel.

In some preferred embodiments of the present invention, it may be difficult to retrieve a message that has been posted at a social media platform such as Facebook®. Under these circumstances, if the consumer first views a certain message via Facebook®, then system 100 will delete or mark as read redundant copies of the message which were sent via other channels, such as being made accessible from a web portal account or being sent via a mobile application. However, if the consumer first views the redundant message via a channel other than Facebook®, such as a SMS text message, then system 100 will attempt to delete the redundant Facebook® message or mark the redundant message as being read if allowed by Facebook®, or, if further action is not possible, then no action will be taken.

In addition to informational messages, a message originator may compose a survey for posting on a message recipient's Facebook® wall. A survey will typically comprise a list of questions and answers. Message recipients can mark a correct answer from a list of possible answers. In other questions, an answer box is provided so that message recipients can enter an open-ended response. When the message recipients answer the questions, the answers are sent to system 100. In some embodiments of the present invention, a message originator can send a quiz to students in their class, and the students can respond to the quiz, all via Facebook®. Similarly, students may be authorized to submit assignments to the teacher using Facebook® posts and the teacher will be able to view the submitted assignments in the teacher's Facebook® news feed. Assignment may be submitted as an attachment to a Facebook® post.

The answers provided by the message recipients are then machine-graded by system 100 and sent to a grade book where the scores for each student are associated with a unique identifier for the student as a message recipient. The scored version of the quiz, showing which questions were missed by the student, can be sent to the student via a post to the web portal account, a Facebook® message, an email, or an SMS text message. Alternatively, a copy of the scored quiz or the score for the scored quiz can be sent to a message recipient who has a trusted relationship with the student such as the student's mother or father.

In an alternative preferred embodiment of the present invention, a message originator may elect to provide messages that can be viewed or accessed by third parties not directly associated with the message originator's organization. For example, a message originator from one school district may authorize other school district personnel to view, share and otherwise use the news feed for the message originator's school district.

System 100 may also be used in various calendaring applications. For example, a school district may wish to post calendar events to a central location, accessible via a URL. Each calendar will have a generated ID and a unique URL so that the app on a message recipient's mobile device 190 can only display the calendar if it knows the URL. In other words, a message could be sent to a message recipient with a unique URL containing a nonobvious identifier for the message recipient such as “dssfafsf22324ffsadf” instead of “John Smith” to identify the calendar. This makes it more difficult for an unauthorized viewer to guess the URL for the calendar. Even if an unauthorized person was able to guess the URL for a private calendar, the private calendar may not contain information about the owner of the calendar because the information displayed would be tied to the nonobvious identifier associated with the intended message recipient.

Similarly, a message originator may choose to make their calendar visible to other users. For example, while attending a professional conference or convention, a message originator may send a message to other conference attendee that displays the unique schedule/agenda of the message originator while attending the conference. The message originator can view their own private calendar and receive messages from the conference sponsors to get directions and even location information. A directory of attendees could be accessed that shows all of the superintendents who will participate and their biographies. The message originator could select which individuals should receive their calendar and send a message to the selected individuals.

System 100 could also be adapted for use by religious organizations, a bowling league, and an inside sales team, among other groups. For example, the sales manager of the inside sales team could easily follow each of the sales reps as they made their appointed sales calls. If the sales reps have mobile communication devices 190 with GPS information activated, then the manager could see if the sales people were going to their appointments and see the calendar for each reps. System 100 could generate alert messages to the sales director if the sales people were not following their schedule.

Some preferred embodiments of the present invention pr vide a feedback button with a optional feature that allows for anonymous tips. A message recipient can rate a message or respond to a message (or a message's content) to let the message originator know if the message was effective in accomplishing its intended purpose. Additional statistics such as message reach; time of message consumption, total number of message recipients that accessed a given message, and other relevant data may be collected and analyzed by system 100 to provide messaging analytics for enhanced messaging.

Users of system 100 can be allowed to search a directory containing the names and related information for individuals or groups from the directory, and request a meeting with the selected individuals or groups. In this embodiment of the present invention, system 100 determines which is the most convenient time for the selected individuals or groups to meet by analyzing the calendars for the individuals and the groups. System 100 then sends a message to each intended participant and proposes a convenient meeting time for at least two of the selected individuals or groups.

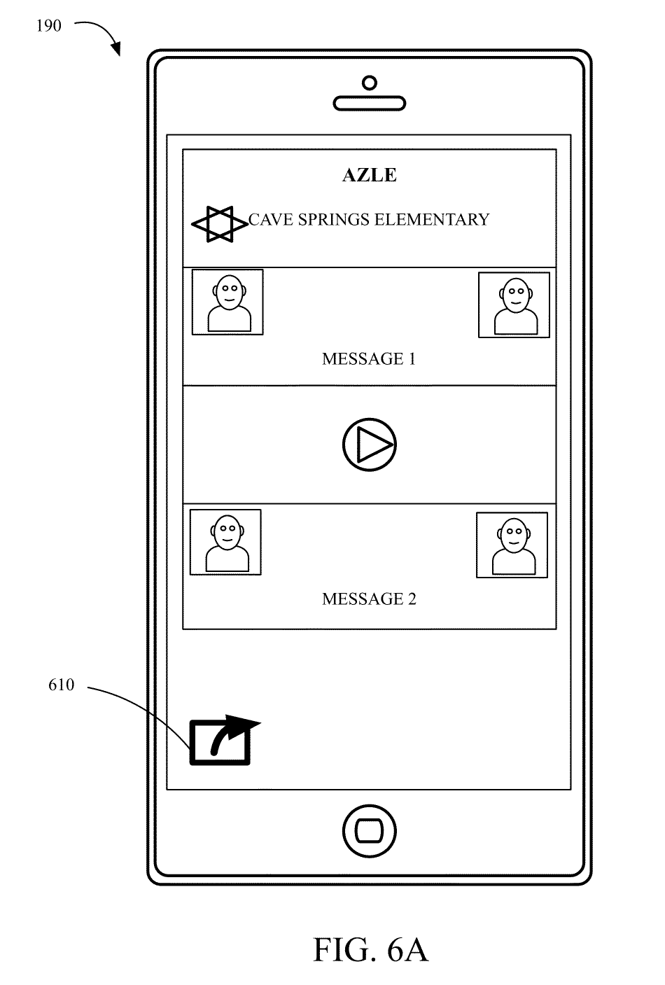

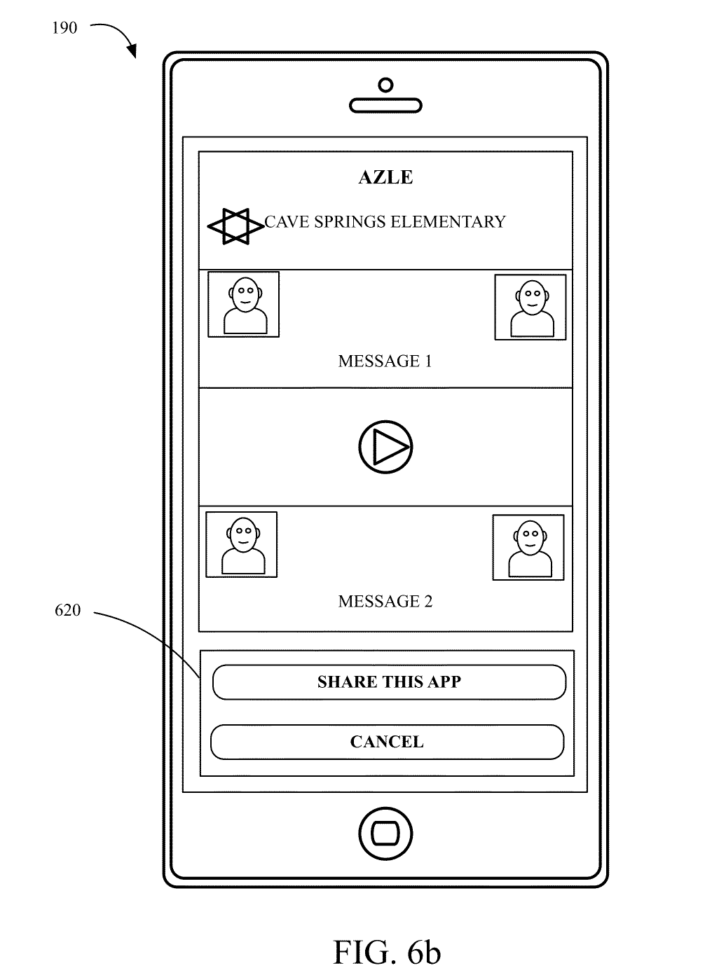

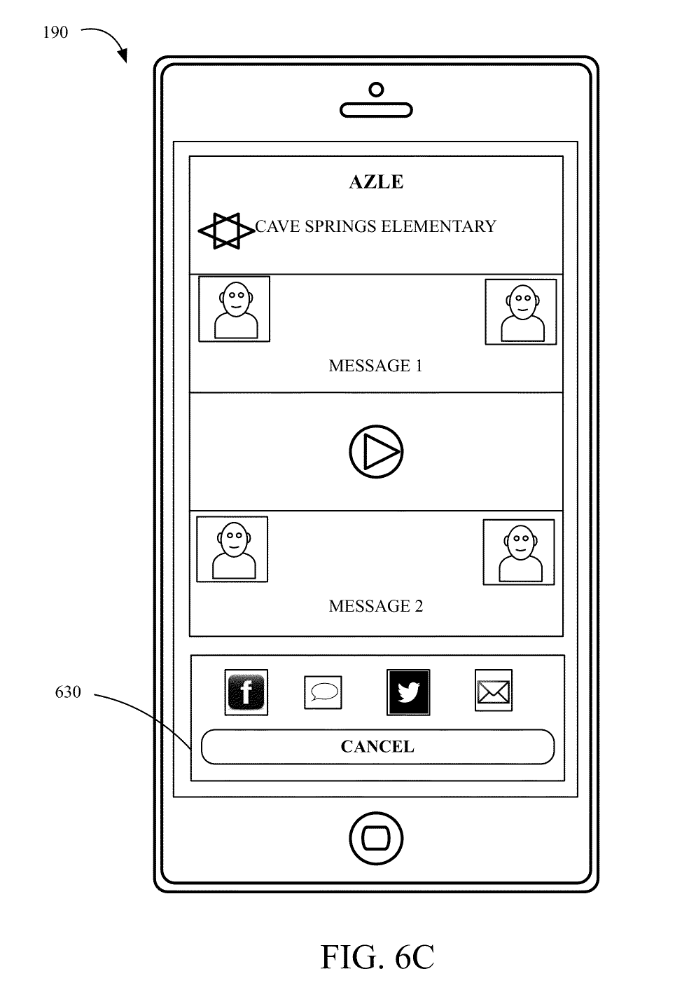

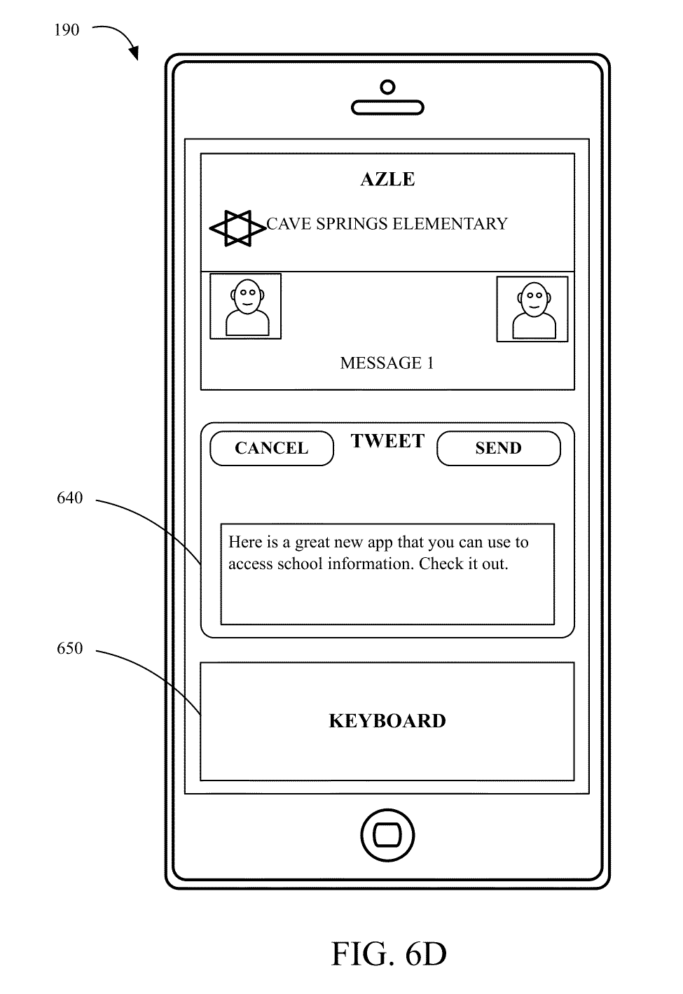

Referring now to FIG. 6A, a user interface 600 for recommending the use of system 100 to third parties is depicted. As shown in FIG. 6A, user interface 600 is displayed on mobile communication device 190. User interface 600 comprises a referral icon 610. A user of mobile communication device 190 can select or click on referral icon 610 to alert friends, co-workers, etc, about the availability of system 100 and make system 100 available to others via various communication methods.

Referring now to FIG. 6B, the user of mobile communication device 190 has selected referral icon 610 and a dialog box 620 is now displayed to the user of mobile communication device 190. The user of mobile communication device 190 can elect to share the app or cancel, thereby returning to the previous display.

Referring now to FIG. 6C, the user of mobile communication device 190 has elected to share the app and the user interface now displays a dialog box 630 highlighting the various sharing options available to user of mobile communication device 190. For example, in this case, user of mobile communication device 190 can elect to use email, Facebook®, Twitter®, or text messaging to alert a friend, co-worker, etc. about the availability of system 100 and the associated mobile app and, by clicking on the desired messaging medium, the message can be sent.

Referring now to FIG. 6D, the user of mobile communication device 190 has elected to send a message via Twitter® and a standard Twitter® user interface dialog box 640 and keyboard 650 is displayed in the user interface. The user of mobile communication device 190 can compose a message and send the tweet off to all those who followers subscriber to their Twitter® feed. Upon receipt of the tweet, the subscribers can elect to install the app to access system 100 via their own mobile communication device 190. In this fashion, the viral nature of social media can be used to spread the use of system 100.

As will be appreciated by one skilled in the art, various aspects of the computer-based system for providing customizable communication disclosed herein may be embodied as a system, method or computer program product. Accordingly, aspects of the computer-based system for providing customizable communication may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the computer-based system for providing customizable communication may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the computer-based system for providing customizable communication may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

From the foregoing description, it should be appreciated that computer-based system 100 and method for customized messaging disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing one or more preferred exemplary embodiments of the present invention, it being understood that various changes may be made in the function and arrangement of elements described in the exemplary preferred embodiment without departing from the spirit and scope of the invention as set forth in the appended claims.

1. A computer-based system for controlling the delivery of a message from a message originator to a message recipient comprising:
at least one processor;
at least one memory coupled to the at least one processor;
a social media messaging platform;
a database residing in the memory, the database comprising a plurality of user authentication credentials for the social media messaging platform;
a message control mechanism residing in the memory; and
at least a first message, the at least a first message being transmitted from the message originator to the message recipient via the message control mechanism and the social media messaging platform, the message control mechanism extracting at least one of the plurality of user authentication credentials from the database, the message control mechanism being configured to post the at least a first message to a social media account associated with the message recipient by using the at least one of the plurality of user authentication credentials to authenticate the message to the social media messaging platform without providing any information about the social media account associated with the message recipient to the message originator.

2. The computer-based system of claim 1 wherein the social media messaging platform comprises at least one of Facebook, Twitter, and MySpace.

3. A method for controlling message flow from a message originator to a message recipient, the method comprising the steps of:
accessing a message control mechanism;
preparing a message to be delivered from a message originator to a message recipient;
storing the message in a message queue;
accessing a set of authentication credentials from a database, the set of authentication credentials providing access to a user account associated with the message recipient on a social media messaging platform;
delivering the message from the message queue to the message recipient via the social media messaging platform without providing any information about the user account for the message recipient to the message originator.

4. The method of claim 3 wherein the social media messaging platform comprises at least one of Facebook, Twitter, and MySpace.
